(19) United States
(12) Patent Application Publication
(10) Pub. No.: US 2013/0169510 A1
(43) Pub. Date: Jul. 4, 2013

(54) INFORMATION PROCESSING SYSTEM

(71) Applicant: Panasonic Corporation, Osaka (JP)

(72) Inventors: Yasutaka Tahara, Osaka (JP); Dai Fujikawa, Osaka (JP); Hirofumi Asakura, Osaka (JP); Hikaru Fujiwara, Osaka (JP); Shinji Goto, Hokkaido (JP)

(73) Assignee: Panasonic Corporation, Osaka (JP)

(21) Appl. No.: 13/710,288

(22) Filed: Dec. 10, 2012

(30) Foreign Application Priority Data
Dec. 29, 2011 (JP) 2011-290255

(51) Int. Cl. G09G 5/00

(52) U.S. Cl. CPC G09G 5/00; G09G 2356/00
USPC 345/1.3

(57) ABSTRACT

The present information processing system processes information through communication between a first information processing device and a second information processing device. The first information processing device is provided with a device detection unit that, if the case where the first information processing device and second information processing device are in proximity or in contact, the detection unit detects the position of the second information processing device. The first information processing device is provided with a first monitor unit that displays information, a first selection unit that selects information displayed by the first monitor unit, and a first communication unit that transmits the selected information to the second information processing device if first selection unit has selected information and moved the selected information across a first region a screen edge of the first monitor unit in a selected state.

### CROSS-REFERENCE TO RELATED APPLICATIONS

This application claims priority under 35 U.S.C. §119 to Japanese Patent Application No. 2011-290255 filed on Dec. 29, 2011. The entire disclosure of Japanese Patent Application No. 2011-290255 is hereby incorporated herein by reference.

### BACKGROUND

1. Field of the Invention

The present technology relates to information processing systems, and more particularly to information processing systems in which information is processed through communication between a first information processing device and a second information processing device.

2. Description of the Related Art

Heretofore, there exists technology for controlling a plurality of monitors with a single terminal. For example, two screens disclosed in JP 2002-533777A can be controlled by a single terminal. This technology is known as dual display technology. This dual display technology enables a user to simultaneously view various information on a larger screen.

With conventional dual display technology, icons, software windows and the like displayed on a screen can be freely moved from one screen to another screen, for example. That is, with dual display technology, icons, software windows and the like can be moved seamlessly between two screens. The user is thereby able to freely form a layout that he or she desires and improve viewability.

On the other hand, following the development of mobile environments in recent years, there is increasing opportunity for users to have more than one terminal and to perform tasks using multiple terminals. In this case, it is also possible to form a dual display environment, using the respective monitors of a plurality of terminals. However, because the abovementioned dual display technology involves a single terminal controlling two monitors, this technology cannot necessarily be utilized effectively, in the case where terminals are used with mobile applications. For example, as far as configurations in which terminals are used with mobile applications are concerned, it is often more effective to be able to move or copy data between a plurality of terminals than to move images between a plurality of monitors. In view of this, construction of a system in which data can be easily processed between a plurality of terminals is desired.

The present technology was made in view of the abovementioned points, and it is an object of the present technology to provide a system in which information can be easily processed between a plurality of terminals.

### SUMMARY

This information processing system processes information through communication between a first information processing device and a second information processing device. The first information processing device is provided with a device detection unit that detects the position of the second information processing device when the first information processing device and the second information processing device are in proximity or in contact. The first information processing device is provided with a first monitor unit that displays information, a first selection unit that selects information displayed by the first monitor unit, and a first communication unit that transmits the selected information to the second information processing device if first selection unit has selected information and moved the selected information across a first region a screen edge of the first monitor unit in a selected state.

The present technology enables information to be easily processed between a plurality of terminals.

### BRIEF DESCRIPTION OF THE DRAWINGS

FIG. 1 is a schematic diagram showing a relationship between a mobile device and a personal computer (PC) according to one embodiment.

FIG. 2 is a diagram showing a hardware configuration of the mobile device according to one embodiment.

FIG. 3 is a diagram showing a hardware configuration of the PC according to one embodiment.

FIG. 4 is a diagram for illustrating proximity sensors of the PC according to one embodiment.

FIG. 5 is a diagram for illustrating transmission-enabled regions set in the PC and a transmission region in the case where the mobile device is in proximity to the PC, according to one embodiment.

FIG. 6 is a diagram for illustrating transmission-enabled regions and a transmission region set in the mobile device according to one embodiment.

FIG. 7 is a flowchart showing processing in the information processing system according to one embodiment.

FIG. 8 is a diagram for illustrating switches of the PC according to another embodiment.

### DETAILED DESCRIPTION OF THE INVENTION

### Description of Embodiments

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

Description of Devices constituting Information Processing System

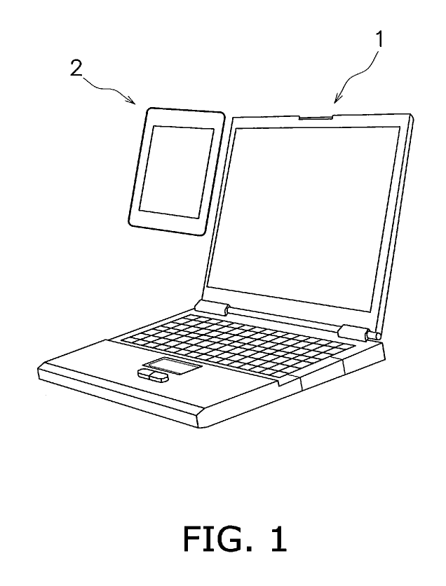

An information processing system is a system in which information is processed through a plurality of devices communicating with each other. For example, as shown in FIG. 1, an information processing system is constituted by a personal computer 1 (exemplary first information processing device; hereinafter referred to as a PC), and a mobile device 2 (exemplary second information processing device).

Configuration of Mobile Device

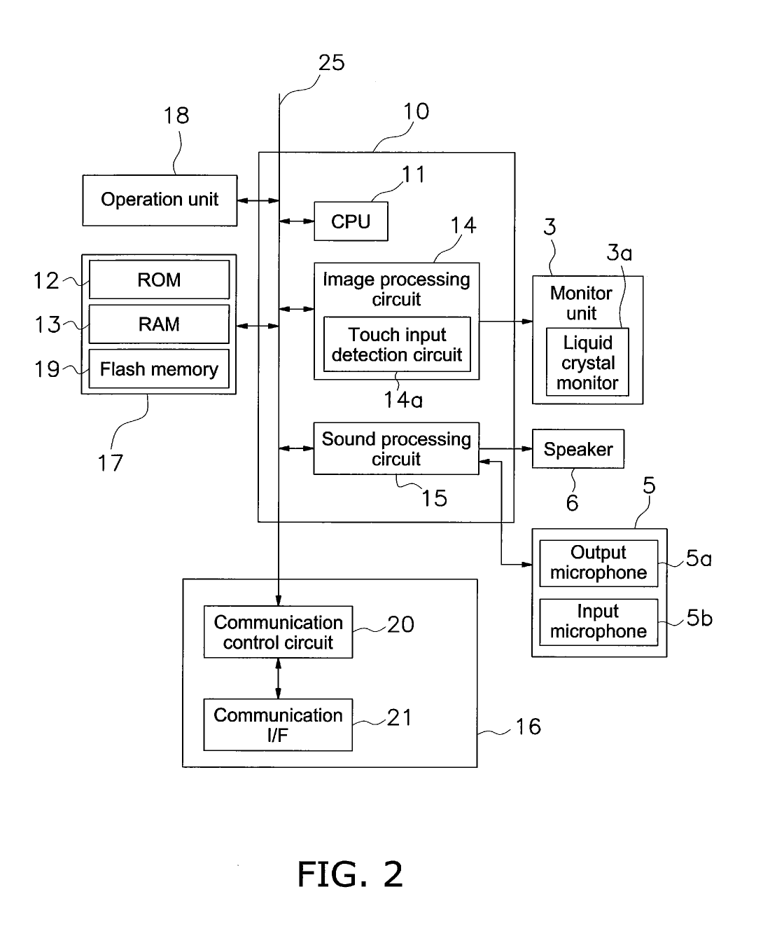

As shown in FIG. 2, the mobile device 2 mainly has a control unit 10 (exemplary second control unit), a monitor unit 3 (exemplary second display unit), a communication unit 16 (exemplary second communication unit), a storage unit 17, and an operation unit 18.

The monitor unit 3 has a liquid crystal monitor 3a (exemplary second monitor unit). The liquid crystal monitor 3a is a contact input monitor such as a touch panel monitor, for example. Information encompassing various data, image information, character information and the like is displayed on the liquid crystal monitor 3a. When a finger, a touch pen or the like (selection means) contacts the touch panel at the position of information (object) displayed on the liquid crystal monitor 3a, the object is selected.

The control unit 10 has a CPU 11 (Central Processing Unit) that utilizes a microprocessor, an image processing circuit 14, and a sound processing circuit 15. These constituent elements are respectively connected via a bus 25. The CPU 11 interprets and executes commands from programs. Also, the CPU 11 interprets input/output commands, and executes input and output of data. Furthermore, the CPU 11 executes writing and reading of various data with respect to the storage unit 17.

The image processing circuit 14 controls the monitor unit 3 according to draw instructions from the CPU 11 to display a prescribed image on the liquid crystal monitor 3a (exemplary second monitor unit). Also, the image processing circuit 14 includes a touch input detection circuit 14a (exemplary second selection unit). In the case where the touch panel is contacted with instruction means such as a finger, for example, a contact signal is supplied from the touch input detection circuit 14a to the CPU 11, and the contact position on the liquid crystal monitor 3a is recognized by the CPU 11.

For example, when a finger, a touch pen or the like (selection means) contacts the touch panel at the position of an object displayed on the liquid crystal panel, an object selection signal is supplied from the touch input detection circuit 14a to the CPU 11, and the object is recognized by the CPU 11. More specifically, when the position coordinates of a finger, a touch pen or the like are recognized within a prescribed region (ex., display region of icon, upper frame portion of software window, etc.) of an object (ex., when touch input, etc. is executed), the object is selected.

The sound processing circuit 15 generates an analog audio signal that depends on a sound command from the CPU 11, and outputs the generated signal to a microphone 5a for sound output and/or a speaker 6. The volume of the microphone 5a for sound output and/or the speaker 6 is adjusted using a volume button of the operation unit 18. Also, the sound processing circuit 15 converts the analog audio signal into a digital audio signal, when sound is input from a microphone 5b for sound input.

The communication unit 16 has communication functions for data communication, for communication as a telephone, and the like. The communication function for data communication encompasses a local wireless network function, an Internet connection function utilizing wireless LAN, and the like.

The communication unit 16 has a communication control circuit 20 and a communication interface 21. The communication control circuit 20 and the communication interface 21 are connected to the CPU 11 via the bus 25. The communication control circuit 20 and the communication interface 21 control connection signals for connecting the mobile device 2 to a local wireless network, the Internet via a wireless LAN, and the like, according to commands from the CPU 11. Also, the communication control circuit 20 and the communication interface 21 control connection signals for connecting the mobile device 2 to other devices via Bluetooth (registered trademark) and the like, according to commands from the CPU 11.

Also, the communication control circuit 20 and the communication interface 21 receive and control connection signals from other devices. Furthermore, when communicating by telephone, the communication control circuit 20 and the communication interface 21 control connection signals for connecting the mobile device 2 to a telephone line, according to commands from the CPU 11.

The storage unit 17 is built into the main body, and is connected to the bus 25. For example, the storage unit 17 has a ROM 12 (Read Only Memory), a RAM 13 (Random Access Memory), and a flash memory 19. The ROM 12 records programs required for basic control (e.g., startup control, etc.) of the mobile device 2, and the like. The ROM 12 has recorded therein programs relating to data processing, file control, basic control, and the like.

The RAM 13 functions as a work memory of the control unit 10. The RAM 13 is realized by an SDRAM or the like. The RAM 13 also functions as an internal memory for recording various data, image information, audio information, and the like. The flash memory 19 is a rewritable nonvolatile memory. Basic programs, various data, and programs for hardware control are recorded in the flash memory 19. Also, an OS (Operating System) is installed in the flash memory 19. Note that the flash memory 19 may also be integrated into the RAM 13.

The operation unit 18 has a home button, a volume button and the like which are not shown. When the home button is pressed, a home screen is displayed, the mobile device 2 is restored from a sleep state, or the like. When the volume button is pressed, the volume is increased or decreased.

Note that although interface circuits mediate between the bus 25 and each constituent element if needed, illustration thereof is omitted here.

Configuration of PC 1

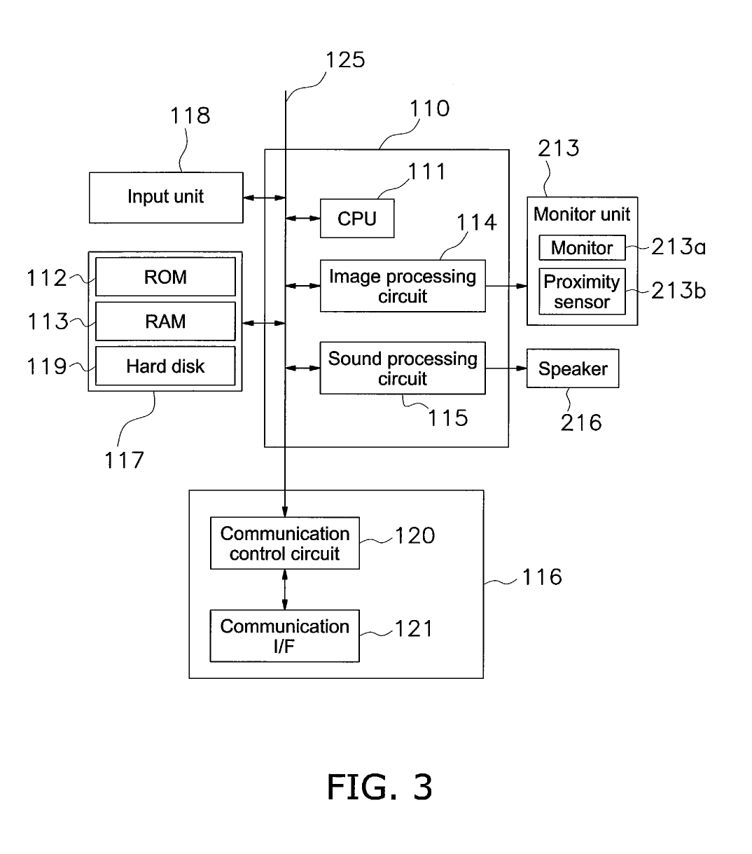

As shown in FIG. 3, the PC 1 mainly has a control unit 110 (exemplary first control unit), a monitor unit 213 (exemplary first display unit), a communication unit 116 (exemplary first communication unit), a storage unit 117, and an input unit 118 (exemplary first selection unit). The functions of the constituent elements 110, 116 and 117 shown here are basically similar to the mobile device 2. Thus, hereinafter, functions that are similar to the mobile device 2 will be described briefly, and functions that are the different from the mobile device 2 will be described in detail. Functions that are omitted here are intended to be equivalent to functions of the mobile device 2.

The monitor unit 213 has a monitor 213a (exemplary first monitor unit) and a proximity sensor 213b (exemplary device detection unit). Information including various data, image information and character information is displayed on the monitor 213a.

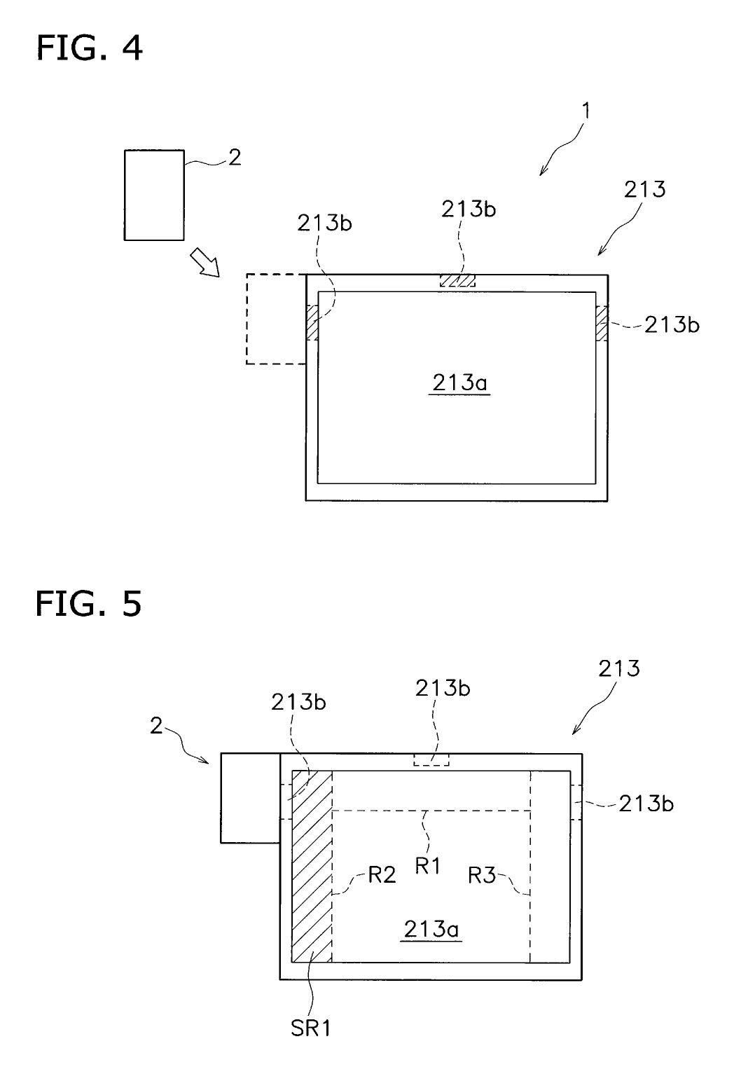

The proximity sensor 213b is a sensor that, in the case where another device approaches PC1, detects the presence of that device. The proximity sensor 213b is built into a peripheral portion of the main body of the monitor unit 213. For example, three proximity sensors 213b are provided in the monitor unit 213. More specifically, the three proximity sensors 213b are respectively built into an upper edge portion, a left edge portion and a right edge portion of a peripheral portion of the main body of the monitor unit 213 (see FIG. 4).

To be specific, the proximity sensors 213b are constituted by a light emitting element that emits light and a light receiving element that receives light and converts the light into an electrical signal, both of which are not shown. When light is emitted from the light emitting element, this light hits the detection target and is reflected back. Then, the light receiving element receives this light and converts the received light into a voltage. When the resultant voltage is greater than or equal to a given value, it is determined that the detection target has approached to within a given distance.

Note that although an example is given here in the case where the proximity sensors 213b are infrared proximity sensors, the proximity sensors 213b may be any type of proximity sensor. For example, the proximity sensors 213b may be inductive proximity sensors, capacitance proximity sensors, or ultrasonic proximity sensors.

The control unit 110 has a CPU 111, an image processing circuit 114, and a sound processing circuit 115. These constituent elements are respectively connected via a bus 125. The CPU 111 interprets various commands and executes various processing. The image processing circuit 114 controls the monitor unit 213 based on draw instructions from the CPU 111 to display a prescribed image on a monitor 213a. Here, the monitor 213a may be a touch panel or may be a non-touch panel.

The sound processing circuit 115 generates an analog audio signal that depends on a sound instruction from the CPU 111, and outputs the generated signal to a speaker 216. Note that, in the present embodiment, it is assumed that the throughput of the CPU 111 of the PC 1 is lower than the CPU 11 of the mobile device 2.

The communication unit 116 has communication functions for data communication and the like. The communication function for data communication encompasses a local wireless network function, an Internet connection function utilizing wireless LAN, and the like. Also, the communication function for data communication encompasses Bluetooth (registered trademark) and the like. The communication unit 116 has a communication control circuit 120 and a communication interface 121.

The storage unit 117 is built into the main body, and is connected to the bus 125. For example, the storage unit 117 has a ROM 112, a RAM 113, and a hard disk 119. The ROM 112 records programs relating to basic control of the PC 1, and the like. The RAM 113 functions as a work memory of the control unit 110. The hard disk 119 is a magnetic disk, for example. Basic programs, various data, and programs for hardware control are recorded in the hard disk 119. Also, an OS is installed in the hard disk 119.

The input unit 118 is a device that is capable of inputting information. The input unit 118 is a keyboard and/or a mouse, for example. A user gives a desired command to the control unit 110 by operating the input unit 118. Also, the user can select information displayed on the monitor 213a, by operating the input unit 118. For example, the user can move an arrow (selection means, instruction means) displayed on the monitor 213a by operating the input unit 118, such as a keyboard and a mouse, for example, and use this arrow to select an icon, a software window or the like displayed on the monitor.

In the PC 1, an object is selected when a selection command (ex., click, etc.) given by the input unit 118 is executed in a state where the position coordinates of selection means (instruction means) are included within a prescribed region of the object (ex., display region of icon, upper frame portion of software window, etc.).

Note that although interface circuits mediate between the bus 125 and each constituent element if needed, illustration thereof is omitted here.

Functions and Operations of Information Processing System

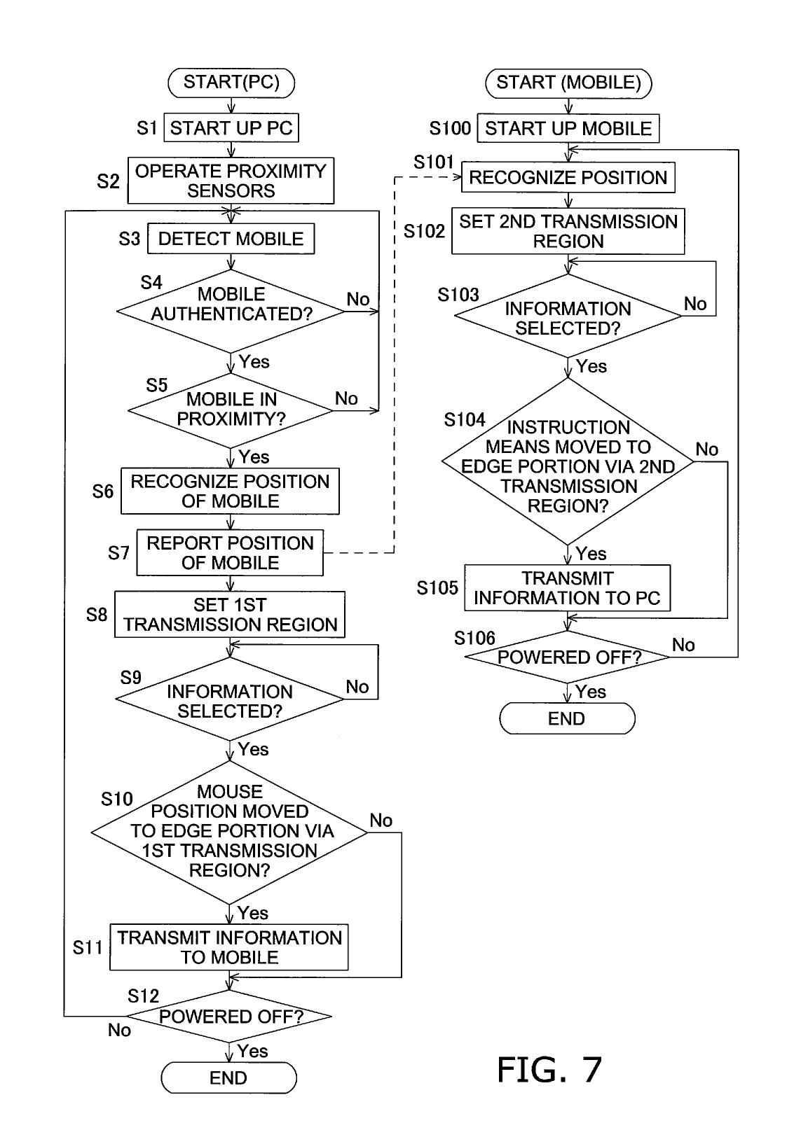

Next, the specific contents of this information processing system will be described. A flowchart shown in FIG. 7 will also be described at the same time. This information processing system is, as shown in FIG. 1, a system in which information is processed through communication between the PC 1 and the mobile device 2 in a state where they are in proximity to each other.

In this information processing system, the PC 1 is controlled by an OS for a PC and the mobile device 2 is controlled by an OS for a mobile device. Note that the OS for a PC and the OS for a mobile device may be different OSs or may be the same OS. Note that, hereinafter, the word “information” may be used to mean “information data”.

First, when the PC 1 and the mobile device 2 are started up (S1, S100), in the PC 1, the three proximity sensors 213b each are activated (S2). In this state, when the mobile device 2 (or the PC 1) approaches the PC 1 (or the mobile device 2) as shown in FIG. 4, each proximity sensor 213b of the PC 1 detects the presence of the mobile device 2 (S3). Then, the CPU 111 of the PC 1 judges whether the mobile device 2 that has approached is a mobile device that is capable of operating with the PC 1 as this information processing system, by authentication using technology such as short-distance wireless communication (S4). The CPU 111 treats a mobile device 2 that is not successfully authenticated as a device that does not come within a prescribed distance (No at S4). The CPU 111 only performs the following processing with respect to a mobile device 2 that is successfully authenticated (Yes at S4).

Then, the CPU 111 of the PC 1 judges whether the mobile device 2 has come within a prescribed distance, based on the output intensity of each proximity sensor 213b (S5). Here, in the case where the mobile device 2 has come within a prescribed distance (Yes at S5), the CPU 111 recognizes the proximal position of the mobile device 2 to the PC 1 (S6).

Specifically, voltage information (exemplary output intensity) corresponding to the distance between each proximity sensor 213b and the mobile device 2 is transmitted to the control unit 110 from each proximity sensor 213b (monitor unit 213). Then, the CPU 111 recognizes the voltage information output by each proximity sensor 213b, that is, three pieces of voltage information. The CPU 111 then extracts the largest of the three pieces of voltage information, and judges whether this maximum voltage information is greater than or equal to a given value. Here, in the case where the maximum voltage information is greater than or equal to a given value, the CPU 111 recognizes the position of the proximity sensor 213b that detected this maximum voltage information as the proximal position of the mobile device 2.

Note that in the case where the mobile device 2 is not in a proximal state (No at S5), the PC 1 waits until the mobile device 2 is in proximity to the PC 1 (S3).

Next, the CPU 111 issues to the communication unit 116 a command for reporting to the mobile device 2 the proximal position of the mobile device 2 relative to the PC 1 (S7). For example, the position information of the proximity sensor 213b that detected the maximum voltage information is transmitted from the PC 1 to the mobile device 2 via the communication unit 116. Then, the mobile device 2 receives the position information from the PC 1 via the communication unit 16 (S 101). The proximal position of the mobile device 2 relative to the PC 1, that is, the position information of the mobile device 2 relative to the PC 1, is thereby recognized by the CPU 11 of the mobile device 2.

Here, position information is information for judging which portion of the PC 1 the mobile device 2 is in proximity to. For example, position information is information indicating the position of one of the upper edge portion, the left edge portion or the right edge portion (discussed later) of the monitor unit 213 of the PC 1.

Next, the CPU 111 sets a first transmission region SR1 (exemplary first region) for transmitting information in the monitor 213a (S8). For example, in FIG. 5, an example is shown in the case where the mobile device 2 is in proximity to the left edge portion of the monitor unit 213 of the PC 1, and the first transmission region SR1 is set to the left edge portion.

The first transmission region SR1 is a region corresponding to the proximity sensor 213b that detected the maximum voltage information. The CPU 111 selects the first transmission region SR1 from three first transmission-enabled regions R1, R2 and R3 provided in a peripheral portion of the monitor 213a. More specifically, in the case where the mobile device 2 is in proximity to the left edge portion of the monitor unit 213 of the PC 1, as shown in FIG. 5, the region corresponding to the proximity sensor 213b of the left edge portion, that is, the first transmission-enabled region R2, is selected as the first transmission region SR1.

Note that, in the present embodiment, the first transmission-enabled region R1 is a region corresponding to the proximity sensor 213b of the upper edge portion, the first transmission-enabled region R2 is a region corresponding to the proximity sensor 213b of the left edge portion, and the first transmission-enabled region R3 is a region corresponding to the proximity sensor 213b of the right edge portion. These correspondences are defined in a correspondence table recorded in the storage unit 117.

Next, the CPU 111 judges whether information displayed on the monitor unit 213 has been selected, based on the input signal from the input unit 118 (S9). For example, the CPU 111 judges whether an icon, a software window or the like displayed on the monitor 213a has been selected by the input unit 118, such as a mouse, for example. Here, in the case where an icon, a software window or the like has been selected by a mouse (Yes at S9), the CPU 111 recognizes the position coordinates of the mouse on the monitor 213a, and records these position coordinates in the RAM 113. Executing this processing at a prescribed time interval enables the CPU 111 to grasp the position of information selected by the input unit 118.

On the other hand, as long as an icon, a software window or the like has not been selected by a mouse (No at S9), the CPU 111 recognizes the position coordinates of the mouse on the monitor 213a but does not record these position coordinates in the RAM 113. In this case, the CPU 111 monitors whether an icon, a software window or the like has been selected by the mouse (S9). Note that, hereinafter, description will be given, taking the case where the selection object of the mouse is an icon as an example.

Next, in a state where an icon has been selected by the mouse (Yes at S9), the CPU 111 judges whether an arrow (indicator) showing the position of the mouse has been moved across the first transmission region SR1 to the left edge of the screen of the monitor 213a (S 10). Specifically, the CPU 111 judges, in a state where an icon has been selected and dragged by the arrow of the mouse, whether the arrow of the mouse has moved across the first transmission region SR1 to the left edge of the screen of the monitor 213a.

Here, in the case where the arrow of the mouse has moved across the first transmission region SR1 to the left edge of the screen of the monitor 213a (Yes at S10), the CPU 111 issues to the communication unit 116 a command for transmitting the information indicated by the icon to the mobile device 2 (S 11). Then, the information indicated by the icon is transmitted from the PC 1 to the mobile device 2 via the communication unit 116.

Then, the mobile device 2 receives the information from the PC 1 via the communication unit 16. Note that processing for transmitting information from the PC 1 to the mobile device 2 may be any processing for moving information and processing for copying information. Also, this information can be edited as appropriate in the mobile device 2.

Note that in the case of the first transmission region SR1 is the first transmission-enabled region R2, the PC 1 transmits data as a result of the arrow of the mouse moving to the left edge of the screen of the monitor 213a. Also, in the case of the first transmission region SR1 is the first transmission-enabled region R1, the PC 1 transmits data as a result of the arrow of the mouse moving to the upper edge of the screen of the monitor 213a. Furthermore, in the case of the first transmission region SR1 is the first transmission-enabled region R3, the PC 1 transmits data as a result of the arrow of the mouse moving to the right edge of the screen of the monitor 213a.

Note that in the case where the icon is not moved to within the first transmission region SR1 by the arrow of the mouse, or in the case where the icon moves to within the first transmission region SR1 but does not move to the edge of the screen of the monitor 213a (No at S10), the information indicated by the icon is not transmitted to the mobile device 2.

The above various types of processing are executed, in a state where the PC 1 has been powered on. Thus, if the PC 1 is powered off (Yes at S12), the CPU 111 of the PC 1 shuts down the PC 1. On the other hand, if the PC 1 is not powered off (No at S12), the CPU 111 of the PC 1 continues to execute the above processing. Note that it is always possible for the PC 1 to be powered off at any time.

On the other hand, in the mobile device 2, in a state where the mobile device 2 has been started up (S 100), the position information of the mobile device 2 relative to the PC 1 is recognized by the CPU 11 (S101). Then, the CPU 11 of the mobile device 2 sets a second transmission region SR2 (exemplary second region) for transmitting information in the liquid crystal monitor 3a (S102). The second transmission region SR2 is a region near the PC 1, and is, for example, a region adjacent to the PC 1.

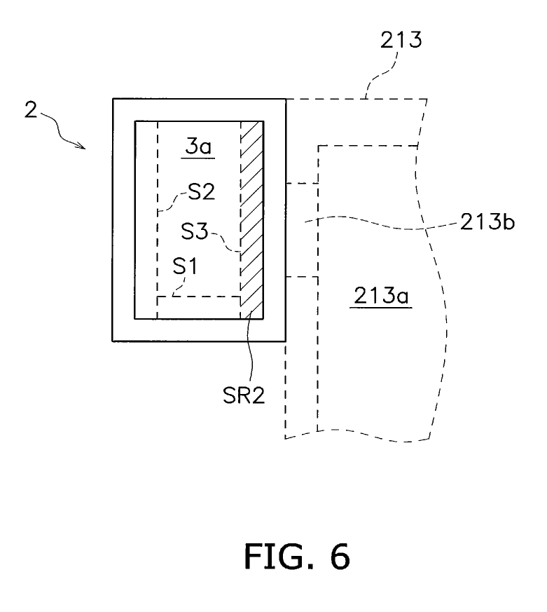

For example, as shown in FIG. 6, the CPU 11 selects the second transmission region SR2 from three second transmission-enabled regions 51, S2 and S3 provided in a peripheral portion of the liquid crystal monitor 3a. More specifically, in the case where the mobile device 2 is in proximity to the left edge portion of the monitor unit 213 of the PC 1, the region corresponding to the proximity sensor 213b of the left edge portion, that is, the second transmission-enabled region S3, is selected as the second transmission region SR2.

Note that, in the present embodiment, the second transmission-enabled region S1 is the region corresponding to the proximity sensor 213b of the upper edge portion, the second transmission-enabled region S2 is the region corresponding to the proximity sensor 213b of the right edge portion, and the second transmission-enabled region S3 is the region corresponding to the proximity sensor 213b of the left edge portion. These correspondences are defined in a correspondence table recorded in the storage unit 117.

Next, the CPU 11 judges whether information displayed on the liquid crystal monitor 3a has been selected, based on the signal from the monitor unit 3 (S103). For example, the CPU 11 judges whether an icon, a software window or the like displayed on the liquid crystal monitor 3a has been selected by instruction means such as a finger or a touch pen. Here, in the case where an icon, a software window or the like has been selected by instruction means (Yes at S103), the CPU 11 recognizes the position coordinates indicating the position (contact position) where the instruction means contacted the liquid crystal monitor 3a, and records these position coordinates in the RAM 13. Executing this processing at a prescribed time interval enables the CPU 11 to grasp the position of information selected by the instruction means.

On the other hand, as long as an icon, a software window or the like has not been selected by the instruction means (No at S103), the CPU 11 recognizes the position coordinates of the instruction means on the liquid crystal monitor 3a but does not record these position coordinates in the RAM 13. In this case, the CPU 11 monitors whether an icon, a software window or the like has been selected by the instruction means (S103). Note that, hereinafter, description is given, taking the case where the selection object of the instruction means is an icon as an example.

Next, in a state where an icon has been selected by the instruction means (Yes at S103), the CPU 11 judges whether the contact position of the instruction means has moved across the second transmission region SR2 to the right edge of the screen of the liquid crystal monitor 3a (S104). Specifically, in a state where the icon has been selected and dragged by the instruction means, the CPU 11 judges whether the contact position of the instruction means has moved across the second transmission region SR2 to the right edge of the screen of the liquid crystal monitor 3a.

Here, in the case where the contact position of the instruction means has moved across the second transmission region SR2 to the right edge of the screen of the liquid crystal monitor 3a (Yes at S104), the CPU 11 issues to the communication unit 16 a command for transmitting information indicated by the icon to the PC 1 (S 105). Then, the information indicated by the icon is transmitted from the mobile device 2 to the PC 1 via the communication unit 16.

Then, the PC 1 receives the information from the mobile device 2 via the communication unit 116. Note that processing for transmitting information from the mobile device 2 to the PC 1 may be any of processing for moving information and processing for copying information. Also, this information can be edited as appropriate in the PC 1.

Note that in the case of the second transmission region SR2 is the second transmission-enabled region S3, the mobile device 2 transmits data as a result of the contact position of the instruction means moving to the right edge of the screen of the liquid crystal monitor 3a. Also, in the case of the second transmission region SR2 is the second transmission-enabled region S1, the mobile device 2 transmits data as a result of the contact position of the instruction means moving to the lower edge of the screen of the liquid crystal monitor 3a. Furthermore, in the case of the second transmission region SR2 is the second transmission-enabled region S2, the mobile device 2 transmits data as a result of the contact position of the instruction means moving to the left edge of the screen of the liquid crystal monitor 3a.

Note that in the case where the icon is not moved to within the second transmission region SR2 by the instruction means, or in the case where the icon is moved to within the second transmission region SR2 but is not moved to the edge of the screen (No at S104), the information indicated by the icon is not transmitted to the PC 1.

The above various types of processing are executed, in a state where the mobile device 2 has been powered on. Thus, if the mobile device 2 is powered off (Yes at S106), the CPU 11 of the mobile device 2 shuts down the mobile device 2. On the other hand, in the case where the mobile device 2 is not powered off (No at S106), the CPU 11 of the mobile device 2 continues to execute the above processing. Note that it is always possible for the mobile device 2 to be powered off at any time.

In Summary

This information processing system processes information through communication between the PC 1 and the mobile device 2. In this information processing system, in the case where the PC 1 and the mobile device 2 are in proximity or in contact, one of the PC 1 and the mobile device 2 detects the position of the other of the PC 1 and the mobile device 2. Then, in the one of the PC 1 and the mobile device 2, if, in a state where the selection means (instruction means) has selected information, the selection means moves across the transmission region SR1, SR2 of the monitor unit 3, 213 to an edge of the screen, the selected information is transmitted from the one of the PC 1 and the mobile device 2 to the other of the PC 1 and the mobile device 2.

As described above, in the information processing system of the present embodiment, information desired by a user can be easily transmitted from the PC 1 (or mobile device 2) to the mobile device 2 (or the PC 1). That is, information can be easily processed between a plurality of terminals (PC 1, mobile device 2). Also, in the case where a difference in processing ability exists between the PC 1 and the mobile device 2, information can be transmitted to and processed by the device having the higher processing ability. That is, information can be efficiently processed by causing the PC 1 and the mobile device 2 to cooperate.

### Additional Embodiments

(A) In the above embodiment, an example was given in the case where the second transmission region SR2 of the mobile device 2 is selected, by detecting, in the PC 1, the position information of the mobile device 2 relative to the PC 1, and transmitting this position information from the PC 1 to the mobile device 2. Alternatively, a configuration may be adopted in which the position of the mobile device 2 relative to the PC 1 can be recognized in the mobile device 2, by providing a device detection unit (ex., proximity sensor) in the mobile device 2. In this case, for example, the device detection unit is built into a peripheral portion (at least one of an upper edge portion, a lower edge portion, a left edge portion and a right edge portion) of the monitor unit 2 of the mobile device 2. Also, the position of the mobile device 2 relative to the PC 1 can be recognized by similar processing to the processing performed by the PC 1 in the above embodiment.

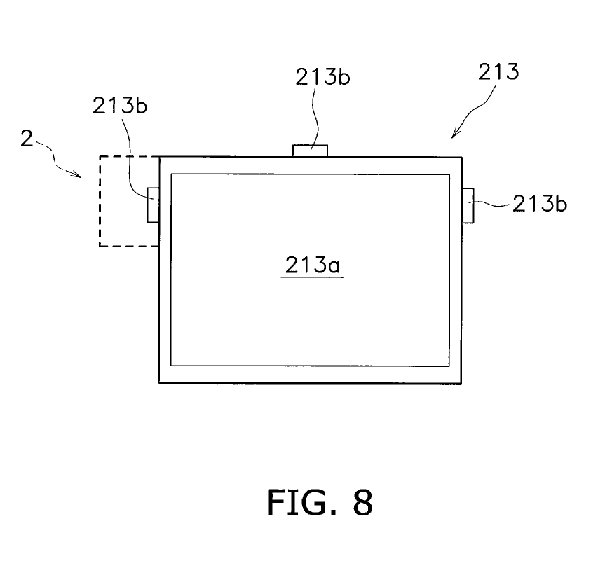

(B) In the above embodiment, an example was given in the case where the position of the mobile device 2 is detected by providing the proximity sensors 213b in the PC 1. Alternatively, a configuration may be adopted in which the position of the mobile device 2 is detected by providing, in the PC 1, a switch 213c for detecting the position of the mobile device 2. In this case, as shown in FIG. 8, the switch 213c is installed in the upper edge portion, the left edge portion and the right edge portion on a peripheral portion of the main body of the monitor unit 213. In the case where a pressing force is applied to any one of the switches 213c by the mobile device 2, the region corresponding to the switch 213c to which the pressing force was applied is set as the first transmission region SR1. In the case where the mobile device 2 is disposed in a position indicated by a dashed line in FIG. 8, a similar region to the above embodiment is set as the first transmission region SR1. Note that the proximity sensor 213b and the switch 213c may be coexist.

(C) Although, in the above embodiment, an example was given in the case where the first transmission-enabled regions R1, R2 and R3 and the second transmission-enabled regions S1, S2 and S3 are band-like regions, the first transmission-enabled regions R1, R2 and R3 and the second transmission-enabled regions S1, S2 and S3 may be any shape.

(D) Although, in the above embodiment, an example was given in the case where the proximity sensors 213b of the PC 1 starts operating automatically when the PC 1 is started up, the proximity sensors 213b of the PC 1 may be operated at any timing. For example, a configuration may be adopted in which the proximity sensors 213b operate as appropriate, based on the input signal from the input unit 118, in the state where the PC 1 has been started up. That is, a configuration may be adopted in which the user manually operates the proximity sensors 213b.

(E) Although, in the above embodiment, an example was given in the case where the PC 1 and the mobile device 2 operate independently of each other, a configuration may be adopted in which, in addition to the above processing, the liquid crystal monitor 3a of the mobile device 2 is used as an extension monitor of the monitor 213a of the PC 1.

(F) In the above embodiment, an example was given in the case where information processing is executed between the PC 1 and the mobile device 2. Alternatively, a configuration may be adopted in which the information processing is executed by PCs, for example.

(G) Although, in the above embodiment, an example was given in the case where the mobile device 2 is in proximity to the left edge portion of the monitor unit 213 of the PC 1, the PC 1 also can detect the proximity of the mobile device 2 at the upper edge portion or the right edge portion of the monitor unit 213.

(H) Although, in the above embodiment, an example was given in the case where the touch input detector circuit 14a is the second selection unit, in the case where the mobile device 2 has an input unit such as a keyboard, the input unit and/or the touch input detector circuit 14a may be used as the second selection unit. Also, in the case where a PC is used instead of the mobile device 2, an input unit of the PC is used as the second selection unit.

The present technology can be widely utilized in information processing systems.

### General Interpretation of Terms

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of the an information processing system. Accordingly, these terms, as utilized to describe the technology disclosed herein should be interpreted relative to the an information processing system.

The term “configured” as used herein to describe a component, section, or part of a device includes hardware and/or software that is constructed and/or programmed to carry out the desired function.

What is claimed is:

1. An information processing system comprising:
a first information processing device;
a second information processing device;
the first information processing device including:
a device detection unit configured to detect a position of the second information processing device respective to the first information processing device if the first information processing device and the second information processing device are in proximity or in contact with one another;
a first monitor unit configured to display information, the first monitor unit including a first region and a screen edge, the first region disposed on the side of the first monitor unit nearest to the second information processing;
a first selection unit configured to select information displayed by the first monitor unit; and
a first communication unit configured to transmit the information selected by the first selection unit to the second information processing device, if the first selection unit moves the information across the first region of the first monitor unit to the screen edge of the first monitor unit in a selected state.

2. The information processing system according to claim 1, wherein:
the first information processing device includes:
a first display unit comprising the first monitor unit and the device detection unit; and
a first control unit configured to set the first region in a peripheral portion of the first monitor unit, and to issue a command to transmit the information selected by the first selection unit to the second information processing device if the first selection unit moves the information selected by the first selection unit across the first region to the screen edge.

3. The information processing system according to claim 2, wherein:
the device detection unit is provided in at least one of an upper edge portion, a lower edge portion, a left edge portion and a right edge portion of the first display unit, and
the first control unit is further configured to:
set a plurality of prescribed regions near each edge portion of the first monitor unit in which the device detection unit is provided, the plurality of regions configured to transmit the information selected by the first selection unit;
select a region of the plurality of regions nearest to where the device detection unit detects the position of the second information processing device to be; and
set the selected region as the first region.

4. The information processing system according to claim 2, wherein:
the first control unit is further configured to:
set a plurality of prescribed regions near each edge portion of the first monitor unit in which the device detection unit is provided, the plurality of regions configured to transmit the information selected by the first selection unit; and
select the first region from the plurality of prescribed regions, based on an output intensity of the device detection unit.

5. The information processing system according to claim 2, wherein:
the device detection unit comprises at least one of:
a sensor unit configured to detect that the second information processing device is in proximity or in contact, and
a switch unit configured to detect the position of the second information processing device based on a pressing force being applied by the second information processing device.

6. The information processing system according to claim 1, wherein:
the second information processing device includes:
a second display unit including a second monitor unit that displays information;
a second selection unit configured to select information displayed by the second monitor unit;
a second communication unit configured to communicate with the first communication unit; and
a second control unit configured to:
set a second region corresponding to the first region in a peripheral region of the second monitor unit; and
issue a command to transmit the information selected by the second selection unit to first information processing device, if the information is moved across the second region to a screen edge of the second monitor unit in a selected state.

7. The information processing system according to claim 6, wherein:
the second communication unit is configured to receive information from the first information processing device.

8. The information processing system according to claim 7, wherein:
the second processing device is configured to edit received information.

9. The information processing system according to claim 6, wherein:
the second display unit is configured as an extension monitor of the first display unit.
